(19) United States
(12) Patent Application Publication
(10) Pub. No.: US 2006/0221600 A1
(43) Pub. Date: Oct. 5, 2006

(54) Lantern With Removable Globe Assembly

(75) Inventors: Norris Richard Long, Wichita, KS (US); Joshua M. Wright, Hong Kong (HK)

Correspondence Address: LEYDIG, VOIT & MAYER, LTD.;(SEATTLE OFFICE), TWO PRUDENTIAL PLAZA, SUITE 4900, CHICAGO, IL, 60601-6780, US

(73) Assignee: The Coleman Company, Inc., Wichita, KS (US)

(21) Appl. No.: 11/277,572

(22) Filed: Mar. 27, 2006

Related U.S. Application Data
(60) Provisional application No. 60/666,013, filed on Mar. 29, 2005.

(51) Int. Cl. F21V 35/00

(52) U.S. Cl. 362/161

(57) ABSTRACT

A lantern (20) that utilizes a portion (24) of a storage case as part of the base for the lantern during use of the lantern. An outer shell or cover (24) of the storage case extends around a globe assembly (50) for the lantern (20) when the lantern is being stored. This cover (24) is then attached to the bottom of the globe assembly (50) to support the globe assembly during use of the lantern. A quick release assembly (94) is provided for simple release of a globe assembly from the lantern so that mantles (68) for the lantern may be easily accessed. Actuation of the quick release assembly (94, 76) releases the globe assembly (50). The globe assembly (50) may then be lifted from a base, such as a collar (48) for the lantern (20).

### REFERENCE TO RELATED APPLICATIONS

This application claims priority to U.S. provisional patent application Ser. No. 60/666,013, filed Mar. 29, 2005, and incorporated herein by reference.

### TECHNICAL FIELD OF THE INVENTION

The present invention relates to lanterns, and more particularly, to fuel burning lanterns.

### BACKGROUND OF THE INVENTION

Lanterns that burn liquid fuel or LP fuel are well known. Such lanterns include a burner assembly to which the fuel is delivered and one or more catalytic mantles which are mounted on the burner assembly. The fuel burns within the catalytic mantles and the mantles incandesce and provide a bright light. The mantles are usually surrounded by a glass cylindrical globe.

Mantles are generally formed from mesh material, and are shaped like a small bag with one open end. The open end is secured around the outlet end of a burner tube of a burner assembly of a lantern. The mantle may be attached, for example, by a drawstring. Alternatively, the mantle may be attached by a spring clip, such as is shown in U.S. Pat. No. 5,639,231.

One problem encountered with prior art lanterns is that the burner tubes are difficult to access for installing or replacement of one or more mantles. Typically, a ventilator cap and the globe have to be removed from the lantern so as to provide access to the mantles. The ventilator cap is often attached by a threaded connection, such as a nut, which requires some time to remove, as well as some dexterity on the part of the user. In addition, because handling of the globe and ventilator cap assembly is required, a user must be careful, because the globe is typically made of glass.

Another problem with prior art lanterns is their storage. Many users store their lanterns in the original box; however, the box may become crushed, torn, or water damaged so that it is no longer usable. Storage cases for lanterns are available, but often as a separate purchase. A consumer may not know such a storage case is available, may not know where to locate one if they are available, or may not want to spend extra money for a storage case. In addition, even if a user has a storage case for the user's lantern, when the lantern is removed from the storage case, there is always an issue of what to do with the storage case while the lantern is being used. For example, the storage case may need to be placed in a car or in a tent during use of the lantern.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a lantern is provided that utilizes a portion of the base of the lantern as a storage case. An outer shell or cover of the storage case extends around a globe assembly for the lantern when the lantern is being stored. This cover is then removed from around the lantern and attached to the bottom of the globe assembly to support the globe assembly during use of the lantern.

In accordance with an embodiment, a quick release assembly is provided for simple release of a globe assembly from around the mantle(s) or other light source (such as a bulb) so that light source for the lantern may be easily accessed. Actuation of the release assembly releases the globe assembly. The globe assembly may then be lifted from a base for the lantern, such as a collar for the lantern. In an embodiment, the globe assembly includes a globe protected by a surrounded encasing which includes a ventilator cap at a top portion. In this manner, the globe does not have to be handled.

Other features of the invention will become apparent from the following detailed description when taken in conjunction with the drawings, in which:

### BRIEF DESCRIPTION OF THE DRAWINGS

FIG. 1 is a side perspective view of a lantern in accordance with an embodiment of the invention, with the lantern in a storage configuration;

FIG. 2 is an exploded side perspective view of the lantern of FIG. 1;

FIG. 3 is an exploded side perspective view of a globe and collar assembly for the lantern of FIGS. 1 and 2;

FIG. 4 is a side perspective view of the lantern of FIG. 1, with the lantern in a use configuration;

FIG. 5 is a partial cut-away, exploded side perspective view of the globe and collar assembly of FIG. 3, with parts removed for detail; and

FIGS. 6-8 are schematic diagrams representing various stages of connection of a globe assembly to a collar of the lantern in accordance an embodiment of the invention.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

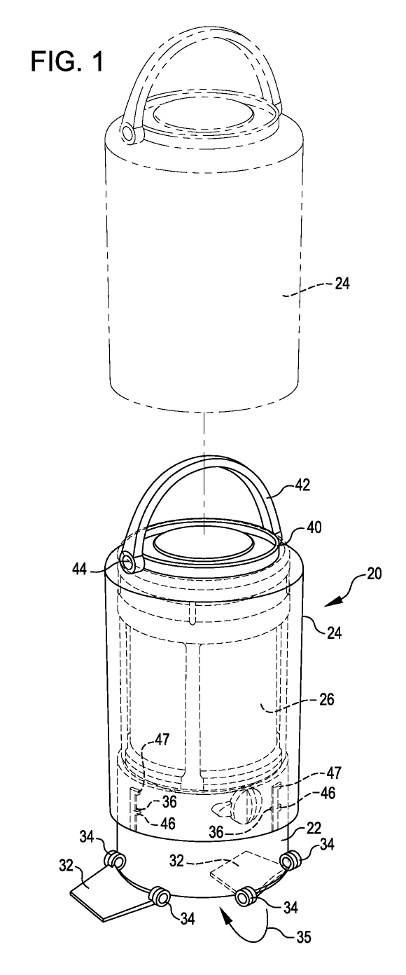

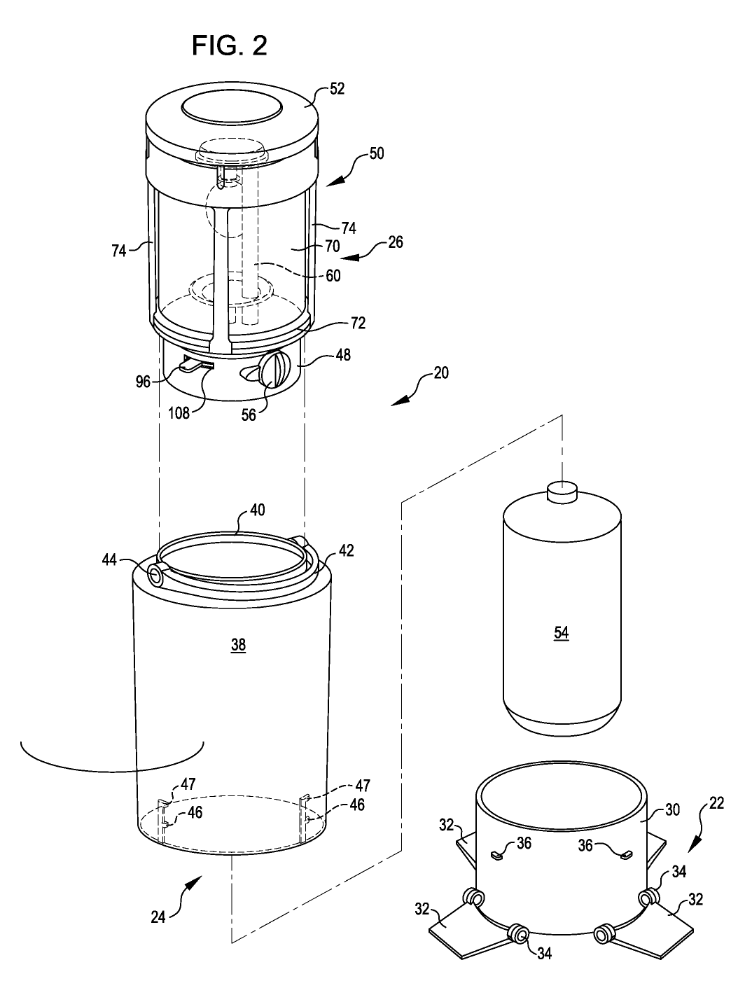

Referring now to the drawings, in which like reference numerals represent like parts throughout the several views, FIG. 1 shows a lantern 20 in accordance with an embodiment of the invention. As can be seen in FIG. 2, the lantern 20 includes a base 22, a cover 24, and a globe and collar assembly 26.

Briefly described, as further described below, the lantern 20 is configured and arranged such that the globe and collar assembly 26 may be stored in the base 22 and the cover 24 in a storage configuration, such as is shown in FIG. 1. In a use configuration, the cover 24 is removed from around the globe and collar assembly 26, the globe and collar assembly is removed from within the base 22, and the globe and collar assembly is mounted on top of the cover 24, which in turn is mounted on top of the base 22, as is shown in FIG. 2.

In the embodiment shown, the base 22 includes cylindrical walls 30, although another shape may be utilized. Feet 32 are rotatably mounted to the bottom of the base 22 at hinges 34. In an embodiment, the feet 32 extend outward so as to provide a broader footprint for the base 22 when the feet 32 are extended. The feet 32 may be folded under the base 22 by rotating the feet about the hinges 34 as is shown by the arrow 35 in FIG. 1.

If desired, rotation of the feet may stopped at a straight outward or other position by a stop, friction in the hinges 34, or another mechanism that provides limited rotation of the hinges 34. In an alternate embodiment, the feet 32 may be adjustable to lock in multiple positions, i.e. two or more positions, so that the feet 32 may be set to account for variations in terrain. In such an embodiment, the feet 32 may be locked in different positions in a number of different ways, including increased friction at these locations, or a locking structure (not shown) for each of the feet 32 for locking the respective foot in a desired orientation. In an embodiment, a stop (not shown) may be provided at a position of full extension.

Protrusions 36 are located on the outside of the cylindrical walls 30. The function of the protrusions 36 is described below.

In the embodiment shown, the cover 24 includes cylindrical walls 38, although a different shape may be used. The cover 24 includes an upper opening 40. A handle 42 is mounted on opposite sides of the upper opening 40 by pins 44 (only one of which is shown in FIG. 2). The cover 24 also includes two sets of interior slots 46, 47 on the inside of the cylindrical walls 38. The interior slots 47 are located above the interior slots 46.

In use, as described above, in accordance with an embodiment, the cover 24 fits over the base 22 in both a storage configuration (FIG. 1) and a use configuration (FIG. 4). In accordance with an embodiment, the cover 24 fits further down onto the base 22 when in the use configuration of FIG. 4 than in the storage configuration of FIG. 1. This feature permits the globe and collar assembly 26 to fit within the base 22 and cover 24 when the two are connected in an expanded state. A shorter, more compact, version of the base 22 and cover 24 encasement is used when the globe and collar assembly 26 are mounted on top of the cover 24. This shorter version aids in preventing tipping of the lantern 20 when in the use configuration.

To store the lantern, the cover 24 is mounted on the base 22 with the globe and collar assembly 26 within the base 22. The cover 24 extends over and around the base 22 and the globe and collar assembly 26 until the inside, top portion of the cover 24 engages the top of the globe and collar assembly 26. At this point, the protrusions 36 are aligned with the lower slots 46. Rotating the cover 24 locks the protrusions 36 on the base 22 into the lower interior slots 46.

When the cover 24 is mounted on the base for the use configuration, the protrusions are locked into the upper interior slots 47. A shelf or other stop (not shown) may be provided on the inside of the cylindrical walls 38 of the cover 24 to limit the amount the cover 24 can be inserted onto the base 22. The amount of insertion permitted by such a stop may be arranged so that, when the cover 24 is installed that amount, the upper interior slots 47 align vertically with the pins 36, and thus the cover 24 is simply rotated to lock the cover into position on the base 22.

Other locks may be provided for the cover 24 and the base 22, including interior or exterior latches, friction fitting, snaps, structures that extend through both the base and the cover, or other suitable structures or methods of limiting or preventing movement of the cover 24 relative to the base 22 after the cover is mounted on the base. In addition, although in the shown embodiment the cover 24 extends outside the base 22, this configuration may be reversed, the two pieces may partly overlap, may abut end-to-end, or may be provided in another arrangement relative to one another. However, in the shown embodiment, when the cover 24 is mounted over and around the base 22, the base 22 is protected from the entry of rain, other debris, and insects. To this end, the cover 24 and the base 22 form a sealed case for the lower part of the lantern 20 when in the use configuration.

The globe and collar assembly 26 includes a collar 48 at a lower portion, and a globe assembly 50 mounted above the collar. In the shown embodiment, a ventilator cap 52 is located at the top of the globe assembly 50.

In general, fuel burning lanterns, such as the lantern 20, include a burner assembly for mixing air and fuel and providing the air and fuel mixture to mantles for the lantern. The components for a burner assembly of a lantern are known, but are generally described in this disclosure for the benefit of the reader. Typically, a lantern such as the lantern 20 includes a regulator (not shown, but known in the art) for dropping the pressure of the fuel from a propane cylinder 54 to a usable pressure for the lantern. The regulator is typically connected to a valve (also not shown) that is connected to a control knob 56, which is mounted on the collar 48 in the embodiment shown in the drawings. Rotation of the control knob 56 increases or decreases the flow of fuel to the burner assembly.

In the burner assembly shown in the drawings, an air-fuel intake tube 60 extends upward from the collar 48 to a manifold 62, very often called a “peanut” in the field of lanterns. A single burner tube 64 extends downward from the manifold 62 to a mantle mount 66.

If desired, an igniter (not shown, but known in the art) may be provided for lighting the lantern 20. The use of such igniters is known, and the details of their structure and operation are not provided herein. As an alternative to an igniter, the lantern 20 may be lit manually such as by a match.

A mantle 68 is mounted on the mantle mount 66. Although a single mantle mount 66 and a single mantle 68 are disclosed, multiple mantle mounts 66 and/or mantles 68 may be utilized. In addition, although a sock mantle is shown in the drawings, a different type of mantle, such as a tube mantle, may be used.

In operation, a user rotates the control knob 56, causing an igniter (if present) to spark (alternatively, a separate push button may be supplied for an igniter, or manual lighting may be used), and gas to be supplied through the air-fuel intake tube 60, through the manifold 62, and out of the burner tube 64 at the mantle mount 66. The mantle 68, which is typically made of a catalytic material such as yttrium, lights and remains lit as long as fuel is supplied to the mantle.

The mantle 68 may be tied, clipped, or otherwise attached to the mantle mount 66. As an example, one structure that may be used to attach the mantle 68 to the mantle mount 66 is disclosed in U.S. Pat. No. 5,637,231. That patent discloses a spring clip for attaching a mantle to a mantle mount.

Although the shown embodiment utilizes mantles and burning fuel, aspects of the present invention may be used with any type of lantern, including but not limited to battery operated lanterns. In such an embodiment, the globe and collar assembly 26 is replaced by an electric light assembly (as opposed to the mantle light assembly of the globe and collar assembly 26), in which a lamp or bulb (not shown) is located generally where the globe assembly 50 is located in the globe and collar assembly 26. A ventilator cap 52 is not needed, because venting is not required for a battery operated lantern. However, embodiments of the invention are practical for use with a burning fuel lantern because of the need to access mantles. In addition, the feature of use of the case as a base is advantageous for a lantern that is attached to a fuel canister, because the cover 24 provides a space for the fuel canister when the lantern is in the use position.

The globe assembly 50 includes a globe 70 mounted below the ventilator cap 52. In the shown embodiment, a bottom edge of the globe 70 rests on a bottom support 72. The bottom support 72 is shaped as a ring that is wider than the bottom edge of the globe 40. Rails 74 extend upward from the bottom support to the ventilator cap 52. The globe 70 is trapped between the bottom support 72 and the ventilator cap 52, and is held in position between the rails 74.

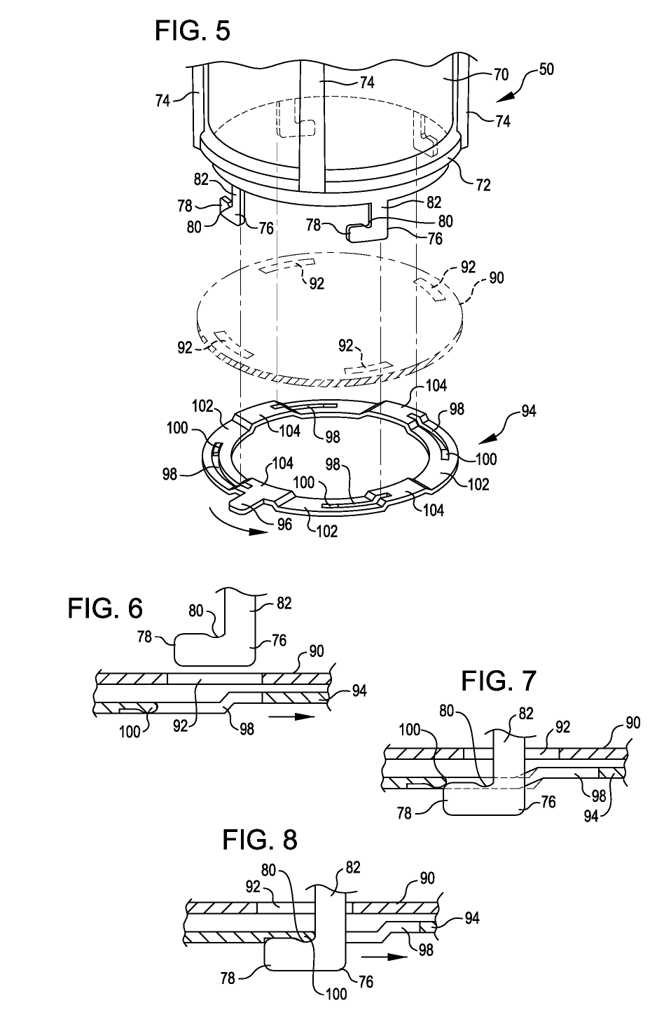

Feet 76 extend from the bottom of the bottom support 72 of the globe assembly 50. In the embodiment shown, each of the feet 76 includes an extension 78 that extends parallel to a bottom of the bottom support 72. Each of the extensions includes a notch 80, best shown in FIGS. 6-8 at a juncture of a downward post 82 for the foot and the extension 78.

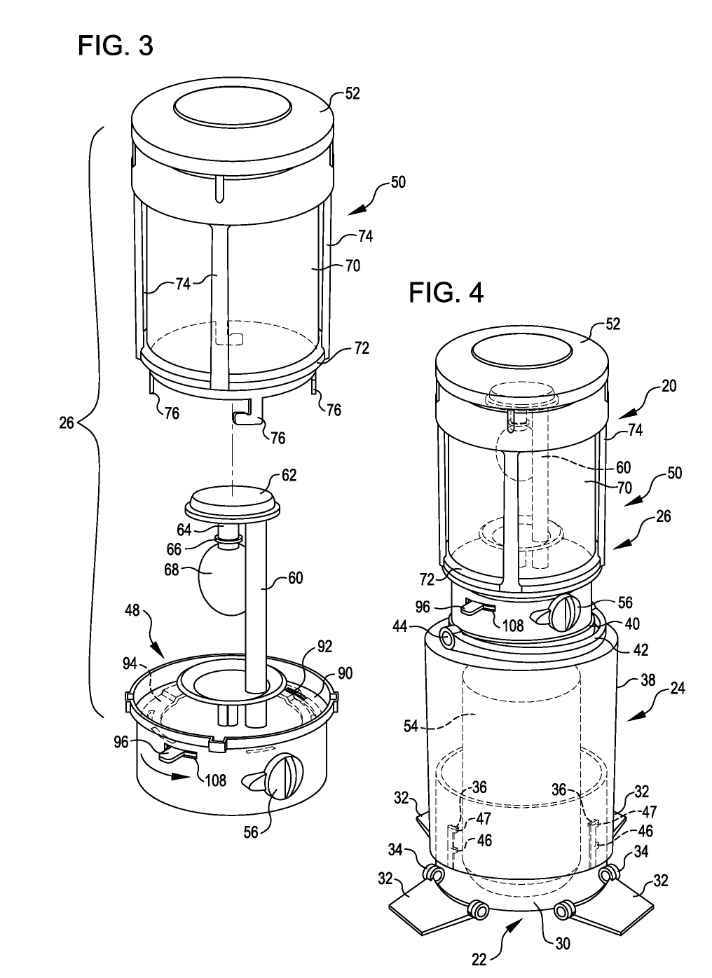

As can be seen in FIGS. 3 and 5, a top portion of the collar 40 includes a top plate 90, having a plurality of slots 92 along an outer periphery. A latch plate 94 is mounted below the top plate 90 and is rotatable with respect to the top plate. The latch plate 94 includes a handle 96 extending outward and slots 98 spaced along the outer periphery. In the embodiment shown, the latch plate 94 is shaped like a ring, although other configurations may be used. A rigid detent spring 100 is positioned at the end of each slot. In the embodiment shown in the drawings, the latch plate 94 includes a series of raised portions 104 and lower portions 102. The raised portions 104 and lower portions 102 aid in rotation of the latch plate 94 relative to the top plate 90, and permit the latch plate 94 to engage with the feet 76, the action of which is further described below.

The handle 96 for the latch plate 94 extends out of a slot 108 in the collar 48 (FIG. 3). Movement of the handle 96 along the slot 108 causes the latch plate 94 to rotate within the collar 48 relative to the top plate 90.

To install the globe assembly 50 onto the collar 48, the slots 92 on the top plate 90 and the slots 98 on the latch plate 94 are aligned such as is shown in FIG. 6. This position is consistent with the position of the handle 96 as shown in FIG. 3. With the slots 92 of the top plate 90 and the slots 98 of the latch plate 94 aligned in this manner, the feet 76 of the globe assembly 50 can be inserted through both sets of slots from the position shown in FIG. 6 to a position similar to that shown in FIG. 7. The handle 96 may then be moved to the right in FIG. 3 so as to rotate the latch plate 94 relative to the top plate 90. This causes the latch plate 94 to move relative to the top plate 90 from the position shown in FIG. 6 (albeit with the feet 76 inserted) to the position shown in FIG. 7, and then further to the position shown in FIG. 8.

During this movement of the latch plate 94 relative to the top plate 90, a forward end of each foot 76 engages the detent spring 100 for its respective slot 98. The flexibility of the latch plate 94, and the arrangement of the raised portions 104 and lower portions 102 permits the latch plate 94 to flex, causing the detent spring 100 to raise and slide over the edge of the foot 76 and then snap into position in the notch 80 of the foot as is shown in FIG. 8. That is, the lower portion 102 adjacent to the detent spring 100 flexes upward after engaged by the foot 76 and remains flexed upward until the detent spring 100 snaps into the notch 80. In this position, the globe assembly 50 is held firmly in place on the collar 48. To release the globe assembly 50, a user grasps the handle 96 and rotates it to the left as in FIG. 3. The user must apply some force to release the detent springs 100 from the notches 80, but with reasonable force this can be overcome. Once the latch plate 94 is moved completely to the position shown in FIG. 6, the slots 92 for the top plate 90 and the slots 98 for the latch plate 94 are once again aligned, and the globe assembly 50 may be removed.

Removal of the globe assembly 50 using the latch plate 94 provides a simple manner in which to release the globe assembly 50 and easily access the mantle 68 for replacement. Thus, the latch plate 94 and the feet 76 on the globe assembly 50 serve as a quick release mechanism for the globe assembly. Other quick release mechanisms may be provided.

In use, the lantern 20 is stored in the position shown in FIG. 1. The feet 32 on the base 22 are folded underneath the base 22 for compact storage. In the storage position, the globe and collar assembly 26 is positioned at the bottom of the base 22, and the cover 24 is placed over the base and around and over the globe and collar assembly 26. The cover 24 is locked onto the base as described above. In this position, an upper portion of the ventilator cap 52 aligns with the upper opening 40 of the cover 24, and holds the upper portion of the globe assembly 50 in place. The base 22 may be sufficiently configured and sized so as to hold a lower portion of the globe and collar assembly 26 in place. In this manner, the lantern 20 is fully protected and is locked into place within the cover 24 and the base 22.

To use the lantern 20, the user releases the cover 24 from the base 22, for example, in the embodiment shown, by rotating the cover 24 relative to the base 22 so as to release the protrusions 36 from the interior slots 46. The cover 24 is then removed from the base 22, providing access to the globe and collar assembly 26. The globe and collar assembly is then placed over the upper opening 40 of the cover 24. A propane cylinder, such as the propane cylinder 54 shown in FIG. 2, is threaded into internal threads (not shown, but known in the art) on the bottom of the collar 48.

The collar 48 may lock into the upper opening 40, may be held in place in the upper opening by the weight of the propane cylinder 54, or an inner lip of the opening may be trapped between the collar and the propane cylinder. After the propane cylinder 54 is attached to the bottom of the collar 48, the cover 24 may be installed on the base 22 as is described above. The feet 32 on the bottom of the base 22 may then be folded out so that the lantern is in the configuration shown in FIG. 4. In this configuration, the lantern 20 is ready for use.

As can be understood, the lantern 20 provides many advantages. First, the globe assembly 50 is easily removed from the collar 48, providing quick and ready access to a mantle 68 for the lantern 20. Second, the cover 24 serves as a portion of a base for the lantern in one configuration and as a portion of an outer casing for a storage vessel for the lantern in a second configuration. Thus, a separate storage case is not needed, and the lantern 20 may be compactly stored.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lantern, comprising:
a light assembly; and
a cover configured to serve as a portion of a stand for the light assembly in a first configuration and as a portion of an outer casing for a storage vessel for the light assembly in a second configuration.

2. The lantern of claim 1, wherein the light assembly further comprises a cap, and wherein the cap fits into a top portion of the cover when the lantern is in the second configuration.

3. The lantern of claim 2, wherein the cap forms a portion of the outer casing when the lantern is in the second configuration.

4. The lantern of claim 2, wherein the light assembly comprises a globe and collar assembly.

5. The lantern of claim 4, wherein the light assembly comprises one or mantles.

6. The lantern of claim 5, further comprising a base, and wherein, in the first configuration, the cover fits on the base, and the light assembly fits on the cover.

7. The lantern of claim 6, wherein, in the second configuration, the cover fits on the base and the light assembly fits within the cover and base.

8. The lantern of claim 6, wherein the cover fits on the base in at least two different arrangements, with the cover fitting on the base in the first configuration defining a first height that is less than a second height where the cover fits on the base in the second configuration.

9. The lantern of claim 8, further comprising a first lock for locking the cover on the base in the first configuration.

10. The lantern of claim 9, further comprising a second lock for locking the cover on the base in the second configuration.

11. The lantern of claim 8, further comprising a lock for locking the cover on the base in the second configuration.

12. The lantern of claim 1, wherein, in the second configuration, the cover fits on the base and the light assembly fits within the cover and base.

13. A lantern comprising:
a light source mounted on a base;
a globe assembly extending around the light source and releasably connected to the base; and
a latch mechanism for releasing the globe assembly from the base and permitting the globe assembly to be moved from around the light source.

14. The lantern of claim 13, wherein the base comprises a collar, and wherein the light source comprises at least one mantle.

15. The lantern of claim 13, wherein the globe assembly and the latching mechanism comprise mating mechanical parts that engage to releasably connect the globe assembly to the base.

16. The lantern of claim 15, wherein the globe assembly comprises a protrusion, and the latch assembly comprises a lock that extends over the protrusion to releasably connect the globe assembly to the base.

17. The lantern of claim 16, wherein the lock comprises a sliding bar that extends over the fastener to lock the releasably latch the globe assembly to the base.

18. The lantern of claim 17, wherein the sliding bar comprises a handle that extends out of the base to permit a user to move the sliding bar between a first position in which the sliding bar extends over the protrusion and a second position in which the sliding bar is moved from extending over the protrusion.

19. The lantern of claim 15, wherein the latching mechanism and the globe assembly comprise two sets of mating mechanical parts that engage to releasably connect the globe assembly to the base.

20. The lantern of claim 19, wherein the latching mechanism comprises a release mechanism for releasing the two sets of mating mechanical parts, the release mechanism being arranged so that the two sets may be released in one movement with a single hand of a user.

21. The lantern of claim 19, wherein, for each set of mating mechanical parts, the globe assembly comprises a protrusion, and the latch assembly comprises a lock that extends over the protrusion to releasably connect the globe assembly to the base.
